(19) United States
(12) Patent Application Publication
(10) Pub. No.: US 2010/0032296 A1
(43) Pub. Date: Feb. 11, 2010

(54) SYSTEMS AND METHODS FOR QUANTITATIVE ANALYTE TRANSFER

(75) Inventors: Malcolm G. Pluskal, Acton, MA (US); Tom Miller, East Boston, MA (US); James Dasch, Needham, MA (US)

Correspondence Address: Pabst Patent Group LLP, 1545 PEACHTREE STREET NE, SUITE 320, ATLANTA, GA, 30309, US

(73) Assignee: Protein Forest, Inc.

(21) Appl. No.: 12/188,119

(22) Filed: Aug. 7, 2008

(51) Int. Cl. G01N 27/447; B32B 3/26

(52) U.S. Cl. 204/601; 428/316.6; 204/451; 204/456; 204/605

(57) ABSTRACT

Systems and methods for enhancing quantitative transfer of analytes to an adsorptive substrate are provided. A preferred embodiment provides an improved transfer system and method that reduces “blow through” of low molecular weight analytes and increases the adsorption of low molecular weight, for example proteins of about 30 kDa or less compared to conventional transfer techniques. It has been discovered that using a secondary porous backing membrane in conjunction with an adsorptive membrane such as nitrocellulose or polvinylidene fluoride increases the efficiency of analyte interaction with the adsorption membrane compared to transfers techniques using the adsorption membrane without the secondary backing membrane. This improvement of quantitative analyte transfer efficiency facilitates a wider range of detection processes, such as direct analysis by MALDI mass spectrometry than in earlier applications of the process without the secondary backing membrane.

### FIELD OF THE INVENTION

The invention is generally related to systems and methods for transferring analytes to adsorptive substrates.

### BACKGROUND OF THE INVENTION

The separation of biomolecules in a sample has become increasingly important, especially as science progresses in its efforts to achieve personalized medicine. Personalized medicine provides treatment regimens and drugs that are known to have or not to have a specific effect in the subject being treated. Analyzing a sample from a subject for specific target compounds is important in providing individualized medicine. These target compounds can be separated using a variety of products and methods. Once separated, the biological molecules can be transferred to other media for subsequent analysis or quantification.

The method of transferring protein out of an electrophoresis medium, such as cross-linked polyacrylamide gel, using an electric field onto an adsorptive membrane solid phase is termed Western Blotting. For this method to be successful the original sample should: a) elute from the electrophoretic separation medium and b) adsorb onto a suitable microporous membrane solid phase substrate. The latter has proven to be difficult to achieve for a wide range of molecular weight proteins. For example, the first generation of polyvinylidene fluoride (PVDF) based blotting substrates based on a nominal 0.45 μM membrane pore size were not able to quantitatively adsorb proteins less than 30 kDa molecular weight (MWt.) under the standard conditions employed in Western blotting. Low molecular weight proteins, i.e. proteins with molecular weights of about 30 kDa or less, traveled through these membranes un-retained and, as a result, were under-represented in the resulting Western blots. This failure to quantitatively adsorb low MWt. proteins of about 30 kDa or less on the membrane solid phase has been termed “blow through” and is thought to be due to the microporous membrane structure being too open and having too low of a surface area. The resulting surface is not able to efficiently provide conditions that promote adsorption of low MWt. proteins to these membrane solid phases.

Blow through has been addressed in later high surface area, smaller pore size microporous membrane substrates, such as ABI ProBlott®, Immobilon-Psq® and Pall FluoroTrans® family of Western blotting membranes. These solid phases reduce the blow through problem considerably, presumably by providing more optimal conditions for adsorption of low MWt. proteins. Unfortunately, they exhibit high background staining with colorimetric stains, such as Amido Black and Coomassie Blue as a consequence of their high surface area and thickness. In addition they are not optimal substrates for immunochemical staining and exhibit low signal response and high background in these assays.

It is therefore an object of the present invention to provide improved methods and systems for the identification and detection of analytes, particularly for proteins of about 30 kDa or less.

It is another object to provide systems and compositions that reduce blow-through of analytes, preferably proteins of about 30 kDa or less.

It is a further object of the present invention to provide a means for quantitative Western blot transfer, avoiding the prior art “blow through” that led to non-quantitative separation due to loss of analytes of about 30 kDa or less.

It is yet another object of the present invention to provide a porous substrate that increases interaction with the adsorptive solid phase during Western blotting transfer.

### SUMMARY OF THE INVENTION

Systems and methods for enhancing transfer of analytes to an adsorptive substrate are provided. A preferred embodiment provides an improved transfer system and method that reduces blow through of low molecular weight analytes and increases the adsorption of low molecular weight analytes, for example proteins of about 30 kDa or less, compared to conventional transfer techniques. It has been discovered that using a secondary porous membrane in conjunction with an adsorptive membrane such as nitrocellulose or polyvinylidene fluoride increases the amount of analyte adsorbed to the adsorption membrane compared to transfer techniques using the adsorption membrane without the secondary membrane.

One embodiment provides a multilayer substrate for analyte transfer including a first layer and a backing, wherein the first layer includes an adsorptive substrate having a first average pore diameter and wherein the backing includes a first permeable membrane having a second average pore diameter that is much smaller than the adsorptive substrate, such that molecular sieving takes place. The permeable membrane can be made from cellulose ester, regenerated cellulose, and modified cellulose such as cellulose acetate, cellulose carbamate, polysulfone, polycarbonate, polyethylene, polyolefin, polypropylene, polyvinylidene fluoride, or combinations thereof.

Another embodiment provides a method for increasing analyte transfer to a substrate including separating analytes in a separation medium having a first and second side, applying the multilayer substrate to the second side of the separation medium, and causing the analytes to move out of the separation medium toward the multilayer substrate, wherein more analytes adsorb to the adsorption substrate compared to the analytes that adsorb to the first layer of the multilayer substrate without the backing. A representative separation medium includes an electrophoretic gel, for example, a polyacrylamide gel. The first layer of the multilayer substrate can be nitrocellulose or polyvinylidene fluoride. The permeable membrane of the multilayer substrate can be cellulose ester, modified cellulose such as cellulose acetate, cellulose carbamate, polysulfone, polycarbonate, polyethylene, polyolefin, polypropylene, polyvinylidene fluoride, or combinations thereof.

Still another embodiment provides an analyte transfer system. The system includes an analyte separation medium having a cathode side and an anode side with the disclosed multilayer substrate covering the anode side of the separation medium. The system also includes a second permeable substrate covering the cathode side of the separation medium. The system optionally includes a means for causing the analytes to move from the cathode side to the anode side. Suitable means for causing movement of analytes include, but are not limited to, commercially available immunoblot devices.

Kits including the disclosed multilayer substrate are also provided. The kits optionally include one or more buffers for facilitating analyte transfer.

### BRIEF DESCRIPTION OF THE DRAWINGS

FIG. 1 is a diagram showing an adsorption membrane with a semi-permeable membrane backing.

FIG. 2 is a diagram showing a multilayered membrane having a semi-permeable membrane contacting an electrophoretic gel contacting an adsorption membrane having a semi-permeable membrane backing.

FIG. 3 is a prospective view of the prior art transfer stack for stacked gels, showing that the semi-permeable/dialysis membrane is never placed in direct contact with the blotting membrane.

FIGS. 4A and 4B show the Western blot transfer to a PVDF membrane with (FIG. 4A) and without (FIG. 4B) a 1 kDa MWCO PVDF dialysis membrane.

FIGS. 5A and 5B show the Western blot transfer to two layers of PVDF membrane with (FIG. 5B) and without (FIG. 5A) a sheet of dialysis membrane in-between the two layers. In FIGS. 5A and 5B, the top image corresponds with the first layer and the bottom image corresponds with the second layer.

### DETAILED DESCRIPTION OF THE INVENTION

### I. Definitions

The term “blow through” refers to polypeptides passing through pores of a solid substrate during a transfer technique such as Western blotting without forming a stable adsorptive interaction with the solid phase.

The term “analyte” refers to a compound or subject to be detected. Preferred analytes include, but are not limited to, polypeptides and nucleic acids and detectable fragments thereof.

The term “small analytes” refers to analytes having a molecular weight of 30 kDa or less.

The term “effective molecular weight cutoff” with regard to porous membranes refers to the observed maximum molecular weight of an analyte that will pass through the membrane. The effective molecular weight cutoff can vary from the predicted molecular weight cutoff based on the average pore size of the membrane. Typically, the effective molecular weight cutoff is less than the predicted molecular weight cutoff when the predicted molecular weight cutoff is based solely on average pore diameter.

### II. Systems and Methods for Small Analyte Detection

Systems and methods providing increased transfer of small analytes, such as polypeptides of about 30 kDa or less, from separation media to a solid substrate are provided. Representative separation media include, but are not limited to, electrophoretic separation media such as electrophoretic gels. Preferred solid substrates include adsorption membranes, such as nitrocellulose or PVDF. In one embodiment improved adsorption of electrophoretically separated analytes onto an adsorptive membrane is accomplished by applying a second membrane to the back of the adsorption membrane prior to transfer. This second membrane can be in direct physical contact with the absorption membrane or can be adhered to the separation medium using, for example, a polyacrylamide solution. The second membrane is porous and permits small molecules, typically charged molecules, to pass through the pores. The effective molecular weight cut off (MWCO) of the second membrane is generally about 1 kDa to about 30 kDa, preferably about 10-25 kDa, even more preferably about 2-5 kDa and reduces or inhibits the passage of analytes above the MWCO through the second membrane. The analytes to be adsorbed or transferred can be obtained from any electrophoretic separation method and/or device, including, but not limited to, SDS-PAGE gel electrophoresis, isoelectric focusing, or dPC™.

In one embodiment, the absorptive membrane, for example, nitrocellulose or PVDF, has a first average pore size and its back surface on the opposite face from the separation medium is covered or backed with a second membrane having a second average pore diameter that is typically at least 90% less than the first average pore diameter of the first membrane.

It will be appreciated that pore diameter is not directly predictive of the effective MWCO. Fluid flow, pressure, and adsorption of substances to the membrane can alter pore size and therefore change the effective MWCO. The average pore size of the second membrane can be less than 0.1 μm. Preferably the second membrane adsorbs less or no analyte relative to the adsorptive membrane. Exemplary secondary membranes include, but are not limited to, cellulose, regenerated cellulose, modified cellulose, cellulose ester, cellulose acetate, cellulose carbamate, polysulfone, polycarbonate, polyethylene, polyolefin, polypropylene, polyvinylidene fluoride, or combinations thereof. The second membrane improves the efficiency of adsorption on the primary adsorptive membrane of low MWt. proteins being transferred from an electrophoretic medium by the influence of a) an electric field, b) or fluid flow facilitated by capillary or hydraulic means and c) passive diffusion.

Placing a suitable smaller pore size secondary membrane, as defined above, behind a single layer of primary adsorptive membrane can lead to improved adsorption of the desired analyte, such as a protein, and reduction of blow through.

FIG. 1 shows an exemplary embodiment 10 in which an electrophoretic gel 12 containing the separated analytes is placed in fluid contact with adsorptive membrane 14. Adsorptive membrane 14 is in fluid contact with a semi-permeable secondary membrane 16. The dashed arrow indicates the direction of analyte flow. The analyte flow can be generated using known methods, for example using an electric current or capillary action.

In one embodiment, the absorptive membrane 14 and the semi-permeable secondary membrane 16 are combined in one substrate, with the absorptive membrane 14 on one side and the semi-permeable secondary membrane 16 on the opposite side of the substrate.

Alternatively, the absorptive membrane 14 and the semi-permeable secondary membrane 16 are two separate, discontinuous substrates.

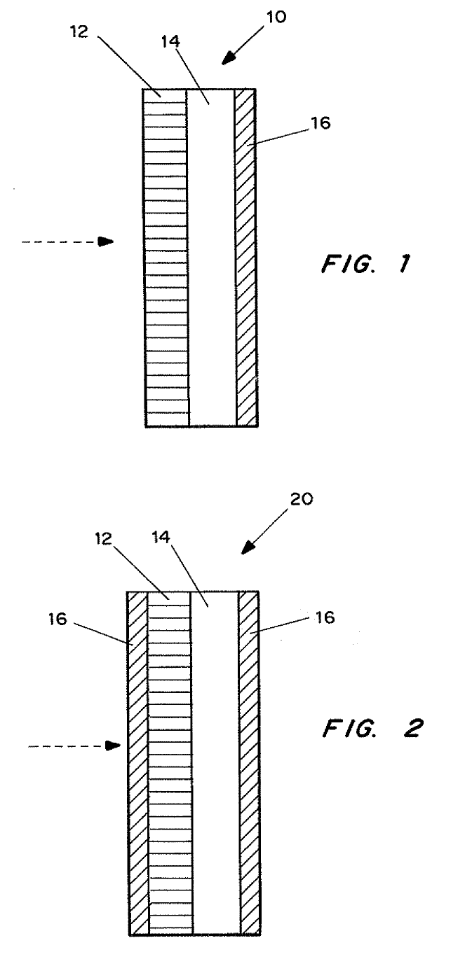

FIG. 2 shows another embodiment 20 in which a semi-permeable secondary membrane 16 is placed over electrophoretic gel 12 and behind adsorptive membrane 14. It is believed that placing a semi-permeable membrane 16 in contact with the electrophoretic gel reduces or inhibits diffusion of the analyte away from adsorptive membrane 14 and thereby increasing transfer efficiency.

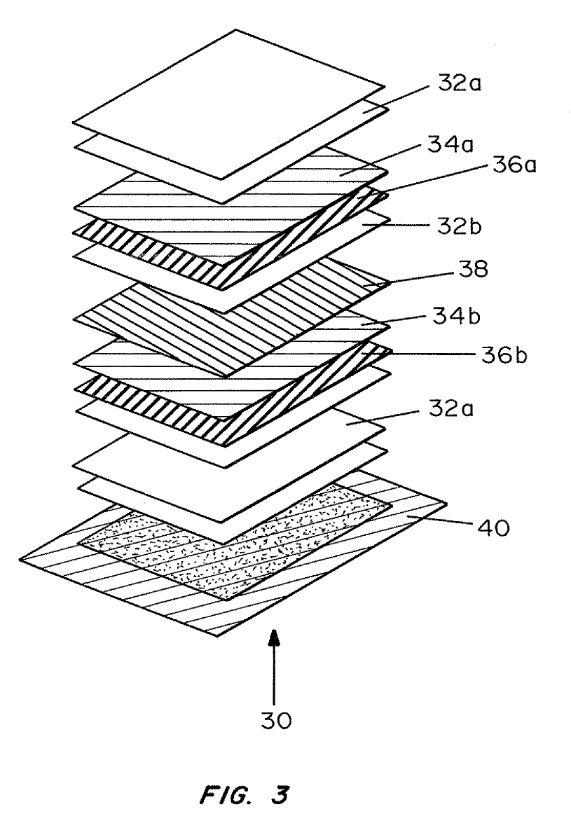

FIG. 3 shows the prior art placement of semi-permeable/dialysis membrane, in a transfer stack 30. Blotting paper 32a is placed next to the gel 34a, which is separated from a second gel 34b by a membrane 36a. This is then placed in abutment with the semi-permeable/dialysis membrane 38, another gel 34c, another membrane 36b, blotting paper 32b, and an optional mask 40.

This technique was applied to Western blotting of proteins focused in the dPC® IEF chip (Protein Forest, Inc.), described in U.S. Pat. No. 7,166,202 and discussed further below. Applied pressure was used to improve assembly during the step where the layers of primary absorptive and semi-permeable/dialysis membranes were placed on the anode side of the solid chip substrate. Typically, gel based separation media cannot resist applied pressure and will collapse. Surprisingly, the applied pressure worked on the dPC® IEF Chip. In addition, a further improvement in analyte detection and transfer efficiency was noted when a second semi-permeable/dialysis membrane was placed on the cathode side of the dPC® chip. The second membrane presumably prevented protein elution from the IEF gel plugs during the applied pressure step away from the solid phase adsorptive layer adjacent to the opposite face of the dPC® IEF chip.

In another embodiment, a layer of polyacrylamide gel is applied to one side of the adsorptive membrane having a semi-permeable membrane backing to form a multi-layer membrane. The multilayer membrane is then placed in contact with the electrophoretic gel so that the layer of polyacrylamide connects the multilayer membrane with the electrophoretic gel. The polyacrylamide layer improves contact between the adsorption layer and the gel, and thereby facilitates analyte transfer. The membranes are pressed together and any air bubbles removed. The acrylamide layer helps to form an integral association between the primary blotting membrane and the plugs or channels on the dPC® chip and was noted to improve blotting reproducibility and performance.

A. dPC® Devices

U.S. Pat. No. 7,166,202 to Zilberstein and Bukshpan discloses a discrete pH trapping device, referred to as the digital proteome chip, or dPC®. Protein Forest's digital ProteomeChip® (dPC®), fractionates complex protein mixtures according to their isoelectric points. The dPC® handles sample volumes up to 1500 μL, containing up to 2.2 mg protein. The entire separation process can be completed in 30 minutes. Sample is added directly to the running buffer so there is no need for a rehydration step. Resolution of the fraction is very high since the pH buffers are less than 0.05 pH units apart. The discrete pH features guarantee pI information. The system is also compatible with all sample types including neat proteins or protein mixes, human cell lysates, bacterial cell lysates, tissue lysates, plasma, and serum. As a result, the dPC™ provides researchers with a fast, easy-to-use, and reproducible tool to enhance their samples prior to complex analyses, such as intact mass, amino acid sequencing, immunoblotting, size separation or tryptic digestion mass spec.

In the dPC®, an array containing a multiplicity of discrete pH features serves as a permeable partition between an acidic anode buffer chamber and a basic cathode buffer chamber. Proteins below their pI in the anode chamber exhibit a net positive charge and migrate toward the cathode through the pH features that maintain the protein below its pI. Conversely, proteins above their pI in the cathode chamber exhibit a net negative charge, and migrate toward the anode through the pH features that maintain the protein above its pI. Proteins tend to accumulate in the pH features closest to their pI, where their net migration is either zero at the pI, or very slow near the pI. The advantage of the dPC® is that by its discrete nature the pH of any specific feature is known according to its formulation, rather than by being extrapolated from known endpoints, as is done in the carrier ampholyte or immobilized pH gradient (IPG) systems. A characteristic of the dPC® system is that the electrophoretic migration of the analytes is not serial to the pH gradient, but random.

B. Polyacrylamide Gels

The electrophoretic separation, including isoelectric focusing (IEF) can be performed in cells of all forms and shapes, notably capillaries, slabs, and tubes. In capillaries the separation medium is most often the buffer solution itself, whereas in slab cells, tube cells and gel-filled capillaries, the separation medium is a gel equilibrated and saturated with the buffer solution.

Gel Substrates

Preferred materials to serve as a substrate for the gel include glass and plastics. The plastic materials used to form the support plates of the cassettes or dPC® chip include a wide variety of plastics. The plastics are generally injection moldable plastics, and the selection is limited only by the need for the plastic to be inert to the gel-forming solution, the gel itself, the solutes (typically proteins) in the samples to be analyzed in the cassette, the buffering agents, and any other components that are typically present in the samples. Examples of these plastics are polycarbonate, polystyrene, acrylic polymers, styrene-acrylonitrile copolymer (SAN, NAS), BAREX® acrylonitrile polymers (Barex Resins, Naperville, Ill., USA), polyethylene terephthalate (PET), polyethylene terephthalate glycolate (PETG), and poly(ethylene naphthalenedicarboxylate) (PEN). Preferred plastics include polyvinylchloride, acrylics, acrylonitrile butadiene styrene (“ABS”), and styrene-acrylonitrile copolymers (“SAN”) but adhesion may be poor.

Monomer Solutions

Gels suitable for electrophoretic separation are described in U.S. Pat. No. 6,197,173 to Kirkpatrick. The gel can be denaturing or non-denaturing. The gel can have various pore sizes. The gel can include additional components such as urea, detergent and a reducing agent as needed. See, e.g., Malloy, et al., Anal. Biochem., 280: 1-10 (2000).

The gel typically is precast of polyacrylamide. The gel is usually cast between two sheets of glass or plastic. Various monomers can be used in addition to the conventional acrylamide/bis-acrylamide solution or agarose solutions to make a gel for use in the first and/or the second dimension. Hydroxyethylmethacrylate and other low-molecular weight acrylate-type compounds are commonly included as monomers. Polymers substituted with one or more acrylate-type groups have also been described in the literature (Zewert and Harrington, Electrophoresis, 13: 824-831 (1992)), as especially suitable for separations in mixed solvents of water with miscible organic solvents, such as alcohol or acetone. Gel-forming monomers can also be any substantially water-soluble molecule containing a photo-polymerizable reactive group, in combination with a material which can form cross-links, provided that the combination, once polymerized, forms a gel suitable for the particular type of electrophoresis.

Exemplary materials include acrylamide, in combination with methylene-bis-acrylamide or other known crosslinkers; hydroxyethylmethacrylate and other low-molecular weight (less than about 300 Daltons) derivatives of acrylic acid, methacrylic acid, and alkyl-substituted derivatives thereof, such as crotonic acid; vinyl pyrrolidone and other low-molecular weight vinyl and allyl compounds; vinylic, allylic, acrylic and methacrylic derivatives of non-ionic polymers, including such derivatives of agarose (“Acrylaide” cross linker, FMC Corp.), dextran, and other polysaccharides and derivatives, such as cellulose derivatives including hydroxyethyl cellulose; polyvinyl alcohol; monomeric, oligomeric and polymeric derivatives of glycols, including polymers of ethylene oxide, propylene oxide, butylene oxide, and copolymers thereof; acryl, vinyl or allyl derivatives of other water-compatible polymers, such as polyHEMA (polyhydroxyethyl acrylic acid), polymeric N-isopropyl acrylamide (which is temperature-sensitive), maleic-acid polymers and copolymers, partially hydrolysed EVAC (polymer of ethylene with vinyl acetate), ethyleneimine, polyaminoacids, polynucleotides, and copolymers of the subunits of these with each other and with more hydrophobic compounds such as pyridine, pyrrolidone, oxazolidine, styrene, and hydroxyacids. The polymerizable materials need not be entirely water-soluble, especially when solvents or surfactants are included in the gel-forming solution.

The gel-forming solution is an aqueous solution of a monomer mixture that is polymerizable, generally by a free-radical reaction, to form polyacrylamide. Monomer mixtures that have been used or are disclosed in the literature for use in forming polyacrylamide gels can be used. The monomer mixture typically includes acrylamide, a crosslinking agent, and a free radical initiator. Preferred crosslinking agents are bisacrylamides, and a particularly convenient crosslinking agent is N,N′-methylene-bisacrylamide. The gel-forming solution will also typically include a free radical initiator system. The most common system used is N,N,N′,N′-tetramethylenediamine (TEMED) in combination with ammonium persulfate. Other systems will be apparent to those skilled in the art.

Among those skilled in the use of electrophoresis and the preparation of electrophoresis gels, polyacrylamide gels are characterized by the parameters T and C, which are expressed as percents. The values of T and C can vary as they do in the use of polyacrylamide gels in general. A preferred range of T values is from about 5% to about 30%, and most preferably from about 10% to about 20%. A preferred range of C values of from about 1% to about 10% (corresponding to a range of weight ratio of acrylamide to bisacrylamide of from about 10:1 to about 100:1), and most preferably from about 2% to about 4% (corresponding to a range of weight ratio of acrylamide to bisacrylamide of from about 25:1 to about 50:1).

Methods for making polymerizable derivatives of common polymers are known in the art; for example, addition of allyl glycidyl ether to hydroxyl groups is known, as is esterification of hydroxyls with acids, anhydrides or acyl chlorides, such as acrylic anhydride. Amines are readily derivatized with acyl anhydrides or chlorides. Many of the derivatized polymers described above will contain more than one reactive group, and so are self-crosslinking. Addition of a crosslinking agent, which contains on average more than one reactive group per molecule, is required for formation of gels from monomers which have only one reactive group, such as acrylamide. These include, in addition to multiply-derivatized polymers, methylene bis-acrylamide, ethylene glycol diacrylate, and other small molecules with more than one ethylenically-unsaturated functionality, such as acryl, vinyl or allyl.

Candidate non-acrylamide monomers can include, e.g., allyl alcohol, HEMA (hydroxyethyl(meth)acrylate), polyethylene glycol monoacrylate, polyethylene glycol diacrylate, ethylene glycol monoacrylate, ethylene glycol diacrylate, vinylcaprolactam, vinylpyrrolidone, allylglycidyl dextran, allylglycidyl derivatives of polyvinylalcohol and of cellulose and derivatives, vinyl acetate, and other molecules containing one or more acryl, vinyl or allyl groups. Addition of linear polymers such as hydroxypropylmethylcellulose (HPMC) and HEMA to the monomer solution is used to increase gel strength.

### Oxygen Scavengers; Adhesion Enhancing Agents

The interface irregularities of polyacrylamide gels that are precast in plastic gel cassettes can be reduced or eliminated by the inclusion of an oxygen scavenger in the gel-forming solution from which the gel is cast. The monomer mixture in the solution is polymerized with the scavenger present in the solution, and the result is a pre-cast gel with a substantially uniform pore size throughout. Band resolution in the cassette is then comparable to the band resolution that can be obtained with polyacrylamide gels in glass enclosures. Oxygen scavengers that can be used include many of the materials that have been used or disclosed for use as oxygen scavengers in such applications as boiler operations where they are included for purposes of reducing corrosion. Examples of these materials are sodium sulfite, sodium bisulfite, sodium thiosulfate, sodium lignosulfate, ammonium bisulfite, hydroquinone, diethylhydroxyethanol, diethylhydroxyl-amine, methylethylketoxime, ascorbic acid, erythorbic acid, and sodium erythorbate. Oxygen scavengers of particular interest include sodium sulfite, sodium bisulfite, sodium thiosulfate, sodium lignosulfate, and ammonium bisulfite. See, e.g., U.S. Pat. No. 6,846,881 to Panattoni. In the most preferred embodiment, the oxygen scavenger is sodium pyrosulfite (Na₂O₅S₂).

These are not limited to isoelectric focusing gels, but are generally applicable to any polyacrylamide gel. Oxygen present in the air, dissolved in gel solution, and/or absorbed onto the surface of the substrate can inhibit, and in extreme cases, prevent acrylamide polymerization. Such inhibition can result in areas interface irregularities where polymerization is incomplete or has not occurred and thus there is no adhesion of the gel to the substrate. Further, oxygen on the surface of the substrate may prevent the polymer as it forms from adhering to the surface.

The amount of oxygen scavenger included in the gel-forming solution can be varied over a wide range. Certain plastics will require a greater amount of oxygen scavenger than others since the amount of oxygen retained in the plastic varies among different plastics and the manner in which they are formed. The optimal amount of oxygen scavenger may also vary with the choice of scavenger. In general, however, best results will be obtained with a concentration of oxygen scavenger that is within the range of from about 1 mM to about 30 mM, and preferably from about 3 mM to about 15 mM, in the aqueous gel-forming solution. The amount of oxygen scavenger used may also affect the optimal amounts of the other components. For example, certain oxygen scavengers display catalytic activity toward the free radical reaction, and a lower concentration of free radical initiator can then be used when such scavengers are present. When a sulfite or bisulfite is used, for example, the concentrations of TEMED and ammonium persulfate (or other free radical initiator system) can be lower than would otherwise be used.

C. Buffers

1. Running Buffers

Electrophoresis can be performed in running buffers of low electrical conductivity and yet achieve high resolution. With low conductivity buffers, electrophoresis can be performed at high field strengths while experiencing less of the difficulties encountered with conventional buffers. Low conductivity buffers permit one to increase the field strength well beyond levels typically used for capillary electrophoresis without a loss in resolution. Buffer solutions are characterized at least in part by conductivity low enough to permit the use of voltages well in excess of the typical voltages used for capillary electrophoresis, without substantial loss in peak resolution. While the conductivity can vary depending on how fast a separation is desired and therefore how high a voltage is needed, best results in most cases will be obtained with conductivities in the range of 25×10⁻⁵ ohm⁻¹ cm⁻¹ or less. In preferred embodiments, the conductivities are within the range of about 1×10⁻⁵ ohm⁻¹ cm⁻¹ to about 20×10⁻⁵ ohm⁻¹ cm⁻¹, and in particularly preferred embodiments, the conductivities are within the range of about 2×10⁻⁵ ohm⁻¹ cm⁻¹ to about 10×10⁻⁵ ohm⁻¹ cm⁻¹. Typical voltages for slab gel range are about 300 volts per cm (along the distance of the direction of the voltage). For capillaries, where the voltages used are generally higher than other forms, voltages are in the range of about 600-750 volts, up to about 2000 volts, per cm of capillary length or greater. See also U.S. Pat. No. 5,464,517 to Hjertén et al.

2. Isoelectric Focusing Buffers

An IEF buffer includes components that have a buffering capacity around a given pH value (buffering agent) or components that organize to form a pH gradient (e.g., ampholytes, immobilines or a combination of buffering agents). The IEF buffer is in the form of a liquid, slurry or a gel such that a biomolecule can pass through IEF buffer unless the pI of the biomolecule is in the pH range of the IEF buffer. An IEF buffer can include other components such as urea, detergent and a reducing agent as needed. See, e.g., Malloy, et al., Anal. Biochem. 280: pp. 1-10 (2000). It is desirable that the IEF buffers are functionally stable under the influence of an electric field.

IEF buffer or cell including the IEF buffer can be formed by hand or by various devices. For example, the IEF buffer can be deposited (e.g., coated, printed or spotted) on the surface of a substrate or in a groove or channel of a substrate. The substrate can be a matrix as described below or a bead made of the same material as the matrix. The IEF buffer can be made by a device that mixes an acidic and basic solution to form a buffer having the desired pH value (“titrator”). The buffer is combined with a monomer (e.g., acrylamide) and polymerizing agent and loaded into another device (“matrix printer”) that lays the IEF buffer in a desired position on the matrix. These devices can be incorporated into an automated system.

Ampholines are a set of various oligo-amino and/or oligocarboxylic acids that are amphoteric (i.e., positively charged in acidic media and negatively charged in basic media), soluble and have Mᵣ values from approximately 300 up to 1000. Ampholytes can be prepared or purchased. For example, several carrier ampholytes are known in the art (e.g., pages 31-50, Righetti, P. G., (1983) Isoelectric Focusing: Theory, Methodology and Applications, eds., T. S. Work and R. H. Burdon, Elsevier Science Publishers B. V., Amsterdam; U.S. Pat. No. 3,485,736). Alternatively, purchased ampholytes include Ampholines (LKB), Servalyts® (Serva), Biolytes or Pharmalytes™ (Amersham Pharmacia Biotech, Uppsala, Sweden).

Immobilines are non-amphoteric, bifunctional acrylamido derivatives of the general formula: CH₂═CH—CO—NH—R. Immobilines can be prepared or purchased. For example, methods for synthesizing immobilines are known in the art (Bjellquist et al., (1983) J. Biochem. Biophys. Methods, 6:317). The immobilines can be copolymerized with the acrylamide to form IPG's (immobilized pH gradients). IPG's can be prepared by methods known in the art or can be purchased.

pH gradients can be formed by mixing amphoteric or non-amphoteric buffers. For example, such buffers and combinations are described in Allen, R C et al., Gel Electrophoresis and Isoelectric Focusing of Proteins: Selected Techniques, Berlin: Walter de Gruyter & Co. (1984); and in U.S. Pat. No. 5,447,612 (Bier). IEF buffering agents include 50 mM glycine, 14 mM NaOH; 50 mM HEPES, 12 mM NaOH; 50 mM THMA, 44.6 mM HCl; 52 mM citrate acid, 96 mM Na₂HPO₄; 50 mM BICINE, 18 mM NaOH; and 50 mM DMGA, 40 mM NaOH. The pH gradient created by the IEF buffer in each cell can have a narrow or a wide pH range (e.g., pH 6.8-pH 7.8 or pH 6.8-pH 12.8, respectively).

An IEF buffer can have an extremely narrow pH range, e.g. 5.50-5.60 (0.1 pH unit or less difference) or ultra narrow pH range, e.g., 5.52-5.54 (0.02 pH unit difference or less). This is possible because an IEF buffer can be one buffering agent that has been adjusted to a certain pH value. In this case, the pH range of the IEF buffer is equivalent to the buffering capacity of the buffering agent around the pH value to which the buffering agent had been adjusted. The term “interval” refers to the incremental difference in a pH value within the pH gradient created by the IEF buffer. The term “step” refers to the incremental difference in pH value between two different IEF buffers. For example, within one cell, the intervals can be as small as 0.02 pH units through the fill pH range in that cell (e.g., pH 6.8, pH 7.0, pH 7.2, etc., in that cell). In another example, the pH “step” between an IEF buffer in cell #1 and cell #2 can be 0.1 pH unit. For example, the IEF buffer in cell #1 can have a pH gradient starting at pH 6.8 and ending at pH 7.8 and the IEF buffer in cell #2 can have a pH gradient starting at pH 7.9 and ending at pH 8.9 (i.e., pH 7.9 minus pH 7.8). The term “pH range” refers to the highest to the lowest pH values in an IEF buffer or a cell including an IEF buffer (e.g., pH 7.9-pH 8.9), or the difference between the highest and lowest pH values in an IEF buffer or a cell including an IEF buffer (e.g., 1.0 pH units). The intervals within a cell do not have to be uniform or sequential. Further, the pH steps between two cells of a plurality of cells do not have to be uniform.

Exemplary Classes of Buffers Include:

(1) Buffering Agents With a Small Number of Charged Groups Per Molecule, and Preferably of a Relatively High Molecular Weight.

The buffering agents may consist of a single species or a combination of two or more species, to provide both acidic and basic buffering groups. In the case of a mixture of two or more species, the molecular weight ranges cited above refer to the molecular weights which are weight-averaged between the species, as well as within any single species which has an inherent molecular weight range. An example of a buffering agent with a molecular weight below 2,000 is a mixture TAPS with pKa of 8.44 and 2-amino-2-methyl-1,3-propanediol with pK of 8.8. Examples of buffering agents with molecular weights of about 2,000 and above are derivatized polyoxyethylenes with one to three, and preferably two, charged buffering groups per molecule. The derivatized polyoxyethylenes may be used in combinations, such as, for example, one containing two basic buffering groups per molecule and a second containing two acidic buffering groups per molecule. One example of such a combination is a mixture of polyoxyethylene bis(3-amino-2-hydroxypropyl) and polyoxyethylene bis(acetic acid) with pK values of approximately 9 and 5, respectively.

(2) Carrier Ampholytes Fractionated to a Narrow pH Range by Isoelectric Focusing.

Carrier ampholytes are well known among biochemists who use electrophoresis, and are widely used for isoelectric focusing. The term “carrier ampholyte” refers to a complex mixture of molecules which vary in their isoelectric points. The isoelectric points span a range of values, with a sufficient number of different isoelectric points among the molecules in the mixture to produce essentially a continuum of values of the isoelectric points. The buffers must be amphoteric, have decent buffering capacities and are able to carry a current. Thus, when a cell or vessel such as a flat plate sandwich, a tube, or a capillary is filled with a solution of a carrier ampholyte and a voltage is applied across the solution with an acid as the anolyte and a base as the catholyte, the individual ampholyte molecules arrange themselves in order of increasing isoelectric point along the direction of the voltage.

Carrier ampholytes can be formed from synthetic substances or from naturally occurring materials. A variety of synthetic carrier ampholytes are available for purchase to laboratories. Examples are the PHARMALYTES® of Pharmacia LKB, Uppsala, Sweden, and the BIO-LYTES® of Bio-Rad Laboratories, Inc., Hercules, Calif., U.S.A. Examples of carrier ampholytes derived from naturally occurring substances are hydrolyzed proteins of various kinds. BIO-LYTES® are polyethyleneimines derivatized with acrylic acid, with molecular weights of about 200 or greater. The variation in isoelectric point results from the large number of isomeric forms of the starting polyethyleneimine, and the range is achieved in a single derivatization reaction.

The carrier ampholyte is isoelectrically focused and a fraction at a selected pH is isolated and recovered. The fractionation and recovery are readily performed by preparative isoelectric focusing techniques using laboratory equipment designed for this purpose. An example of a preparative isoelectric focusing cell is the ROTOFOR® Cell manufactured by Bio-Rad Laboratories. To achieve the best results, the fractionation is preferably performed in such a manner as to achieve as narrow a pH range as conveniently possible. In preferred embodiments, the pH range of the fraction is at most about 0.2 pH units in range, and in the most preferred embodiments, about 0.1 pH units in range. The midpoint of the pH range in these preferred embodiments is from about pH 3 to about pH 10, and most preferably from about pH 5 to about pH 9.

(3) Low Molecular Weight Buffering Ampholytes at Their Isoelectric Points, the Isoelectric Point Being One Which is Close in Value to One of the pK Values of the Ampholyte.

These ampholytes are relatively low molecular weight compounds, preferably with molecular weights of about 500 or less, with buffering groups in free form rather than neutralized to salt form. An ampholyte is dissolved in deionized, carbon-dioxide-free water, and the pH of the resulting solution is very close to the isoelectric point of the ampholyte. The conductivity of the solution is therefore very low. Ampholytes meeting this description which also have a pK value that is approximately equal to the isoelectric point have a substantial buffering capacity sufficient for use as a running buffer for electrophoresis.

These ampholytes preferably have three or more pK values, at least one of which is within about 1.0 of the isoelectric point of the ampholyte. These values can be spaced apart by up to 7 or 8 pK units, or two or more of them can be very close in value. Examples of ampholytes meeting these descriptions are lysine, aspartyl-aspartic acid, glycyl-L-histidine, glycyl-aspartic acid, hydroxylysine, glycyl-glycyl-L-histidine, N-cyclohexyl-iminodiacetic acid, N-(1-carboxycyclohexyD-iminodiacetic acid, and cyclobutane-1,2-bis(N-iminodiacetic acid).

(4) High Molecular Weight Buffering Ampholytes in Which the Acidic and Basic Groups Have the Same or Very Close pK Values.

Preferred ampholytes of this type are derivatized polymers having molecular weights of about 2,500 or greater. Polyoxyethylene glycols are examples of polymers which can be used effectively for this purpose. Derivatization can be achieved, for example, by conjugating the polymer to boric acid or a boric acid derivative at one end and an amino derivative at the other. An example of a boric acid derivative is 3-(aminophenyl)boronic acid; examples of amino derivatives are 2-amino-2-methyl-1,3-propanediol and 2-amino-2-methyl-1-propanol. Substantially equal pK values for the acid and basic groups can be achieved by synthesizing the compound in a manner which will provide the boric acid residue with a pK value which is somewhat higher than that of the amino group residue, then adjusting the pH to the pK value of the amino group by the addition of sorbitol.

D. Substrates

1. Adsorptive Membranes

Adsorptive substrates or membranes that can be used with the disclosed systems and methods are commercially available, for example from Millipore Corporation (Billerica, Mass.) or Pall Corporation (East Hills, N.Y.). Suitable membranes include, but are not limited to, nitrocellulose, polyvinylidene fluoride (PVDF), polytetrafluoroethylene (PTFE), polyethylene, polyurethane, nylon and chemical derivatives thereof. The adsorptive membranes are typically porous and can have an average pore diameter of about 0.1 μm to about 0.65 μm for unsupported cast films and from 0.65 μm to 20 μm for web supported cast films. In the preferred embodiment, the absorptive member is a film cast membrane with an average pore diameter of 0.1 μm to 0.45 μm.

2. Secondary Membranes

Porous membranes that can be used as a secondary membrane or backing can be formed from any of several different natural or synthetic polymers. Preferred porous membranes include, but are not limited to dialysis or ultrafiltration membranes. Exemplary membranes included those made of cellulose, regenerated cellulose, modified cellulose such as cellulose acetate, cellulose carbamate, polysulfone, polycarbonate, polyethylene, polyolefin, polypropylene, polyvinylidene fluoride, or combinations thereof.

The secondary membrane should have a smaller pore size than the adsorptive primary membrane. To optimize results, the pore size difference preferably is in the range of a pore difference of greater than 90% of the primary adsorptive membrane. For example, if the primary adsorptive membrane was 0.1 micron pore size (the lower limit of commercial membranes), the secondary membrane should have a pore size less than 0.01 micron, preferably with a pore size as small as the 0.001-0.005 micron range. Ultrafiltration membranes are thought to have pore sizes in the range of 0.001 to 0.1 micron. Dialysis membranes are less well defined but are thought to be similar in pore size range to the pore size range for ultrafiltration membranes.

The secondary membrane typically has an average pore size that is at least about greater than 90% smaller than the average pore diameter of the absorptive membrane. The pore size of the secondary membrane in combination with physical parameters such as flow rates etc. give the membrane an effective molecular weight cutoff of approximately 30 kDa or less, preferably at least about 20 kDA or less, even less than about 10 kDa. In certain embodiments the effective molecular weight cutoff of the secondary membrane is about 1 kDa to about 5 kDa.

The secondary membrane can be placed in direct contact with the separation medium. Pressure can be applied on the secondary membrane to facilitate contact of the secondary membrane with the separation medium. Pressure is applied perpendicular to the plane of the multilayer substrate in the range of 1-50 psi by direct application of weight or the use of a mechanical device, such as an arbor press to apply force.

Preferred secondary membranes have lower or reduced adsorption of analytes, for example, proteins, compared to the adsorption membrane. In certain embodiments, the secondary membrane has at least greater than 90% less ability to adsorb analytes compared to the adsorptive membrane. In the most preferred embodiment, the secondary membrane layer binds little to no analyte to ensure that quantitative transfer occurs to the primary adsorptive solid phase.

The secondary membrane may be coated with a substance, for example, a polymer or surfactant that reduces the ability of the secondary membrane to adsorb analytes. It will be appreciated that the coating does not interfere with the porosity of the secondary membrane. Ultrafiltration membrane is typically a skin of regenerated cellulose or polyether sulfone cast on top of a melt cast polyethylene or similar support membrane. In many cases the latter has high analyte binding properties. Any treatment of the membrane must result in an immobilized coating, which cannot diffuse into the primary adsorptive layer where it would interfere with analyte binding.

The membranes significantly improve Western blot transfer by making the process quantitative. By ensuring that all the analytes that have been resolved in the electrophoresis medium are transferred to the adsorptive solid phase, it becomes possible to do quantitative studies. In earlier Western blot processes, “blow through” led to a non-quantitative representation of the original separation due to loss of analytes less than 30 kDa molecular weight. Also, the ability to achieve quantitative transfer allows the use of a wider range of subsequently applied assays, such as MALDI mass spectrometry, directly on the blotted sample.

While the exact mechanism has not been established, certain observations have been made. For example, the secondary membrane increases the “residence” time of analytes in the porous structure of the substrate during Western blotting transfer, increasing the probability or chance of a successful interaction with the adsorptive solid phase, thereby leading to quantitative retention of the pattern of analytes resolved in the separation medium.

### II. Secondary Separation Gels

Complex mixtures can be separated in more than one dimension. A very common practice after isoelectric separations is to further separate the analytes according to their molecular weight. Many techniques are utilized in the art to accomplish this. As an illustrative example, the gel device from the first dimension is equilibrated with an ionic surfactant, such as sodium dodecylsulfate (SDS), to impart a uniform charge density to the analytes. These analyte-surfactant complexes are separated according to their molecular weight by observing their electrophoretic migration through a restrictive slab gel. It is usual in conventional isoelectric focusing for the transfer to be to a slab polyacrylamide gel. In the case of the dPC® device, the second dimension can be a slab, if the pH features are arranged in a linear array, or alternatively it can be a multiplicity of columns arranged in a pattern that assures intimate contact with each pH feature of the dPC®. The advantage of the dPC® arrangement is that features of known pH are held in one-to-one correspondence with locations on the second dimension analysis.

In the most common execution of a two dimensional electrophoretic analysis, the second dimension consists of a molecular weight based separation. To accomplish this, analytes separated in the first dimension are complexed with a surfactant, such as sodium dodecylsulfate, that imparts a uniform particle charge density. The protein analyte-surfactant complexes are formed by passive diffusion, or by electrophoretic movement of the surfactant into the first dimension analytical gel. It is advantageous to have an extended stacking gel region that mitigates any inconsistencies in the transfer rate of protein analytes. Any stacking gel, as is known in the art, can be used for this purpose, such as, but not limited to, a low percentage polyacrylamide (less than about 6%) or agarose (less than about 3%). The stacking gel must be greater than 0.5 mm thick and is preferably between 1 and 30 mm.

Other types of devices may be used in the second dimension, including capillary electrophoresis, liquid chromatography, membrane transfer, Western blotting or direct mass spectroscopy device where the first dimension is a matrix and the second dimension or mass spectroscopy is positioned so that the plugs all line up.

For rapid sample screening, the dPC® can be run in a conventional SDS-PAGE format. Since the dPC® gel plugs are in a rigid plastic frame, it is easy to transfer and align the dPC® on a slab gel. The 2D gel image after dPC® fractionation differs from conventional 2D electrophoresis because the pI information is presented from discrete pH gel zones.

To further assure uniformity of contact and analyte transfer between the first and second dimensions, it is advantageous to provide a conductive fluid medium that is non-restrictive to analyte flow, and that serves to fill any gaps between the first and second dimensions. Second dimension running buffers are known in the art. In one embodiment, the stacking gel is cast in place and in contact between the first and second dimensions. Alternatively, a flowable gel, such as, but not limited to, linear polyacrylamide, methyl cellulose, hydroxypropyl methyl cellulose, ethyl cellulose, cellulose ether, xanthan, uncharged polysaccharides, or polyols, or mixtures thereof, can be utilized. The gel must have a low enough apparent viscosity for easy application, but a high enough viscosity so that the gel does not flow out of place within the timescale of the second dimension analysis.

Any of the contact media used between the first and second dimensions may also contain additive components that assist in the electrophoretic migration of the analytes, such as buffers, and/or dyes, such as bromophenol blue, that aid in the visualization of the electrophoresis progress.

### III. Blotting

A. Transfer

Methods for transferring analytes to adsorptive membranes are known in the art. See, e.g., B. D. Hames, editor 3^{rd} ed. Gel Electrophoresis of Proteins: A Practical Approach (1998) Oxford Press, New York, N.Y., p. 207. In one protocol, a piece of PVDF membrane (Millipore Immobion-P™ #IPVH 000 10) is cut and wet for about 30 min in methanol on a rocker at room temperature. The methanol is removed and buffer is added until ready to use.

After a sample is electrophoresed, the protein analytes in the electrophoretic gel are moved onto a membrane made of nitrocellulose or PVDF. The membrane is placed on top of the gel, and a stack of tissue papers are placed on top of the membrane. The entire stack is placed in a buffer solution which moves up the paper by capillary action, bringing the proteins with it.

Another method for transferring the proteins is called electroblotting and uses an electric current to pull proteins from the gel into the PVDF or nitrocellulose membrane. Devices for electroblotting are commercially available. The proteins move from within the gel onto the membrane while maintaining the organization they had within the gel. As a result of this “blotting” process, the proteins are exposed on a thin surface layer for detection. Both the secondary and absorptive membranes are selected for their non-specific protein binding properties (i.e. binds all proteins equally well). Protein binding is based upon hydrophobic interactions, as well as charged interactions between the membrane and protein.

The uniformity and overall effectiveness of transfer of protein from the gel to the membrane can be checked by staining the membrane with Coomassie or Ponceau S dyes, or other dyes. Coomassie is the more sensitive of the two, although the water solubility of Ponceau S makes it easier to subsequently destain and probe the membrane.

Since the membrane has been chosen for its ability to bind protein, and both antibodies and the target are proteins, steps must be taken to prevent interactions between the membrane and the antibody used for detection of the target protein. Blocking of non-specific binding is achieved by placing the membrane in a dilute solution of protein, typically Bovine serum albumin (BSA) or non-fat dry milk, with a minute percentage of detergent such as Tween 20™. The protein in the dilute solution attaches to the membrane in all places where the target proteins have not attached. Thus, when the antibody is added, there is no room on the membrane for it to attach other than on the binding sites of the specific target protein. This reduces “noise” in the final product of the Western blot, leading to clearer results, and eliminates false positives.

B. Detection

Analytes transferred to adsorptive membranes can be detected using a variety of conventional techniques. A preferred detection technique uses antibodies specific for a particular polypeptide. The primary antibody can be detected using any one of several techniques. A variety of methods to detect specific antibody-antigen interactions are known in the art and can be used in the method, including, but not limited to, standard immunohistological methods, immunoprecipitation, an enzyme immunoassay, and a radioimmunoassay. In general, the polypeptide-specific antibody will be detectably labeled, either directly or indirectly. Direct labels include radioisotopes; enzymes whose products are detectable (e.g., luciferase, β-galactosidase, and the like); fluorescent labels (e.g., fluorescein isothiocyanate, rhodamine, phycoerythrin, and the like); fluorescence emitting metals, e.g., ¹⁵²Eu, or others of the lanthanide series, attached to the antibody through metal chelating groups such as EDTA; chemiluminescent compounds, e.g., luminol, isoluminol, acridinium salts, and the like; bioluminescent compounds, e.g., luciferin, and aequorin (green fluorescent protein).

The adsorptive membranes containing transferred proteins may then be washed with suitable buffers, followed by contacting with a detectably-labeled polypeptide-specific antibody. Detection methods are known in the art and will be chosen as appropriate to the signal emitted by the detectable label. Detection is generally accomplished in comparison to suitable controls, and to appropriate standards.

One embodiment provides a method for increasing analyte transfer to a substrate by first separating analytes in a separation medium having a first and second side. The separation medium is typically an electrophoretic gel containing the analytes. A multilayer substrate for analyte transfer is applied to the side of the gel that will be in contact with the anode during Western blot transfer. The multilayer substrate includes a first adsorptive layer and a secondary backing layer, as described above. The first layer includes an adsorptive substrate having a first average pore diameter in the range 0.1 μm to 0.45 μm. The backing includes a first permeable membrane having a second average pore diameter that is at least 90% smaller in diameter than the first average pore diameter. The analytes are caused to move from the separation medium in the direction of the anode to the multilayer substrate. More analytes will interact with the adsorptive substrate of the multilayer substrate compared to the analytes that interact with the first layer of the multilayer substrate without the secondary backing. The porous secondary backing membrane increases the efficiency of adsorption of small analytes, for example polypeptides of about 30 kDa or less.

### IV. Kits

Another embodiment provides a kit containing a multilayer membrane. The multilayer membrane has a first layer containing an absorption membrane having a first average pore diameter. The adsorption layer is preferably nitrocellulose or PVDF. A second layer contacts and covers the first layer. The second layer includes a second membrane having a second average pore diameter wherein the second average pore diameter is less than the first average pore diameter. The second layer is preferably a dialysis membrane. Dialysis membranes can be made of synthetic or natural polymers. Representative dialysis membranes are made from cellulose ester, regenerated cellulose or PVDF. The second layer could also be an ultrafiltration membrane positioned with the ultrafiltration skin layer against the back face of the primary adsorptive membrane. The first and second layers can be pressed together to form the multilayer membrane. Alternatively, the layers can optionally be chemically cross-linked or adhered to one another using conventional techniques. One or more multilayer membranes can be packaged together or individually, preferably under a vacuum. Optionally, pre-cast polyacrylamide gels can be included in the kit.

The components of the kit are packaged in a container suitable for shipping. Additional reagents can optionally be included, for example reagents for detecting transferred analytes, written instructions for using the membranes, and buffers for use with the membranes.

### EXAMPLES

### Example 1

### Western Blot Transfer to a PVDF Membrane With and Without a 1 kDa MWCO Dialysis Membrane

Western blot transfer of 2 ng/gel plug of a biotinylated sample (protein labeled with biotin-NHS reagent and dialyzed to removed unreacted label) of Ovalbumin “cast in place” using cross linked polyacylamide. The dPC gel chip with the above protein cast in place was placed in equilibration buffer (7M Urea, 2M Thiourea, 2% (Wt. v) SDS) at 70° C. for 5 min. After rinsing in transfer buffer (10% (v/v) methanol 25 mM Tris base, 100 mM Glycine) the dPC chip was carefully dried to remove excess liquid, then placed onto a sheet of 1 kDA MWCO dialysis membrane (Spectrum Industries) termed the cathode side. On the second upper face (anode) a multilayer substrate consisting of PVDF blotting membrane (Immobilon P, Millipore Corp) attached to a 1 kDa dialysis membrane and 3 layers of blotting paper soaked in transfer buffer were applied with some linear polyacrylamide (0.5% in transfer buffer) placed on the exposed face of the PVDF membrane to facilitate contact with the dPC chip. Pressure (10 lb weight) was applied to the above assembly for 5 min. After removal of the pressure, the cathode layer and the blotting paper backing on the anode layer were removed.

The PVDF adsorptive membrane+dialysis backing layer were now firmly attached to the face of the dPC chip and were then placed in a prototype tank transfer device (Protein Forest, Inc.) and Western blotted at 2 mA at up to 20 v for 15 min cooling to 10° C. After blotting the PVDF membrane was removed and placed in 5 mL of protein blocking solution (SureBlock, Pierce Biotechnology) for 30 min followed by addition of a Streptavidin-horse radish peroxidase (HRP) enzyme conjugate for detection of the biotinylated Ovalbumin to the 5 mL of blocking buffer and incubated for 30 min. After extensive washing with phosphate buffered saline +0.05% (V/v) Tween-20, the retained HRP was detected using a TMB substrate (InVitrogen).

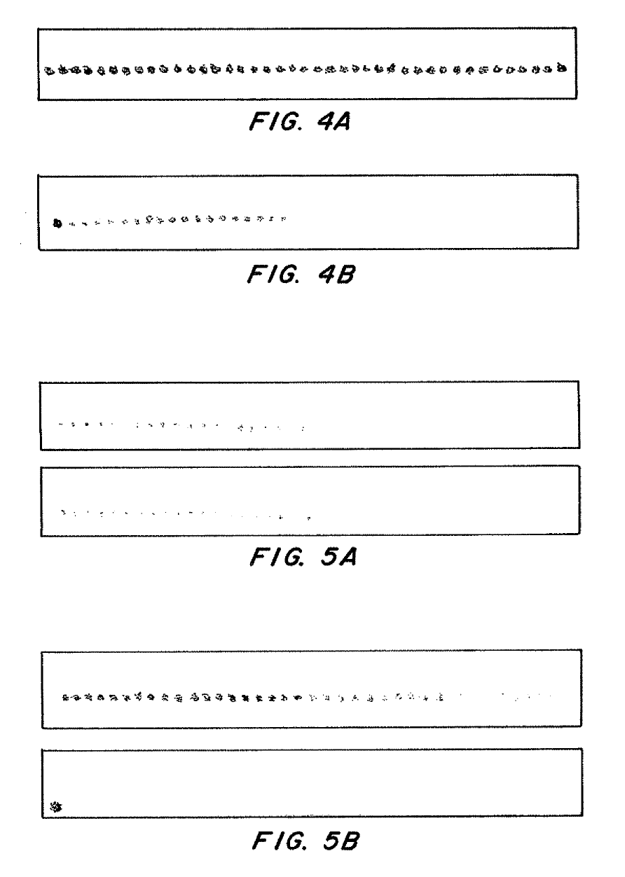

In FIG. 4A, transfer is shown with the dialysis membrane, i.e. a backing layer, in place. FIG. 4B shows the same assembly without the dialysis membrane in place. The quantitative transfer of all wells is readily observed in FIG. 4A and uneven transfer resulting from “blow through” is observed in FIG. 4B.

### Example 2

### Western Blot Transfer to Two Layers of PVDF Membrane With and Without a Sheet of Dialysis Membrane In-Between the Two Layers Preventing “Blow Through”

Western blot transfer and detection were carried out as described above except two layers of PVDF transfer membrane (FIG. 5A) were employed. A second western transfer was set up with a layer of 1 kDa MWCO dialysis (Spectrum Industries) membrane between the two layers (FIG. 5B).

As shown in FIG. 5B, this arrangement resulted in the quantitative transfer to the single sheet of PVDF membrane (adjacent to the separation medium backed with the disalysis membrane) with no “blow through” to the second PVDF membrane. In contrast, in FIG. 5A the two membrane layer showed a weak protein signal, indicating that the transfer was non-quantitative.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

We claim:

1. A multilayer substrate for analyte transfer comprising a first layer and a backing, wherein the first layer comprises an adsorptive substrate having a first average pore diameter and wherein the backing comprises a first permeable membrane having a second average pore diameter that is at least 90% smaller than the first average pore diameter.

2. The multilayer substrate of claim 1 wherein the effective molecular cutoff of the permeable membrane is 300 kDa or less.

3. The multilayer substrate of claim 1 wherein the first layer comprises nitrocellulose or polyvinylidene fluoride.

4. The multilayer substrate of claim 1 wherein the permeable membrane comprises cellulose, regenerated cellulose, modified cellulose, cellulose ester, cellulose acetate, cellulose carbamate, polysulfone, polycarbonate, polyethylene, polyolefin, polypropylene, polyvinylidene fluoride, or combinations thereof.

5. The multilayer substrate of claim 1 comprising an ultrafiltration membrane.

6. The multilayer substrate of claim 1 wherein the multilayer substrate adsorbs more analytes of 30 kDa or less during transfer compared to the first layer without the backing.

7. The multilayer substrate of claim 1 wherein the permeable membrane adsorbs less analyte than the adsorptive substrate.

8. The multilayer substrate of claim 1 wherein permeable membrane does not bind analyte.

9. The multilayer substrate of claim 1 wherein the analytes which are to be transferred comprise peptides between 1 kDa and 10 kDa molecular weight.

10. The multilayer substrate of claim 1 wherein the first adsorptive substrate and the first permeable membrane are contiguous.

11. A method for increasing analyte transfer to a substrate comprising
separating analytes in a separation medium having a first and second side;
applying a multilayer substrate comprising a first layer and a backing, wherein the first layer comprises an adsorptive substrate having a first average pore diameter and wherein the backing comprises a first permeable membrane having a second average pore diameter that is at least 90% smaller than the first average pore diameter, to the second side of the separation medium;
causing the analytes to move out of the separation medium toward the multilayer substrate, wherein more analyte is adsorbed to the adsorption substrate compared to the analyte that adsorbs to the first layer of the multilayer substrate without the backing.

12. The method of claim 11 wherein causing the analytes to move out of the separation medium is accomplished using capillary action or an electric field.

13. The method of claim 11 wherein the effective molecular cutoff of the permeable membrane of the multilayer substrate is 30 kDa or less.

14. The method of claim 11 wherein the first layer of the multilayer substrate comprises nitrocellulose or polyvinylidene fluoride.

15. The method of claim 11 wherein the permeable membrane of the multilayer substrate comprises cellulose, regenerated cellulose, cellulose ester, modified cellulose such as cellulose acetate, cellulose carbamate, polysulfone, polycarbonate, polyethylene, polyolefin, polypropylene, polyvinylidene fluoride, or combinations thereof.

16. The method of claim 11 wherein the permeable membrane comprises an ultrafiltration membrane.

17. The method of claim 11 wherein the multilayer substrate adsorbs more analytes of 30 kDa or less during transfer compared to the first layer of the multilayer substrate without the backing.

18. The method of claim 11 wherein the permeable membrane adsorbs less analyte than the adsorptive substrate.

19. The method of claim 11 wherein the separation medium is an electrophoretic gel.

20. The method of claim 19 wherein the electrophoretic gel is selected from the group consisting of an SDS-PAGE gel, an isoelectric focusing gel, a 2D gel, and combinations thereof.

21. The method of claim 11 wherein the separation medium comprises polyacrylamide or an equivalent hydrophilic aqueous polymer with equivalent physical and chemical properties.

22. The method of claim 11 wherein the first side of the separation medium is a cathode side and the second side of the separation medium is an anode side.

23. The method of claim 11 further comprising applying a second permeable substrate to the first side of the separation medium.

24. The method of claim 11 further comprising joining the multilayer substrate to the second side of the separation medium using a separation medium material.

25. The method of claim 11 wherein the method provides quantitative results.

26. The method of claim 11 wherein the electrophoretic gel is used in an electric transfer process employing a continuous buffer system in a tank electroblotter system or employing a discontinuous system in a semi-dry electroblotter system.

27. An analyte transfer system comprising
an analyte separation medium having a cathode side and an anode side;
the multilayer substrate comprising a first layer and a backing, wherein the first layer comprises an adsorptive substrate having a first average pore diameter and wherein the backing comprises a first permeable membrane having a second average pore diameter that is at least 90% smaller than the first average pore diameter, the multilayer substrate covering the anode side of the separation medium; and
a second permeable substrate covering the cathode side of the separation medium.

28. The analyte transfer system of claim 27 wherein the multilayer substrate of claim 1 is joined to the anode side of the separation medium with a hydrophilic polymeric separation medium.

29. A kit comprising a container housing and the multilayer substrate comprising a first layer and a backing, wherein the first layer comprises an adsorptive substrate having a first average pore diameter and wherein the backing comprises a first permeable membrane having a second average pore diameter that is at least 90% smaller than the first average pore diameter.

30. The kit of claim 29 further comprising one or more buffers for facilitating analyte transfer.
